(19) United States
(12) Patent Application Publication
(10) Pub. No.: US 2006/0178196 A1
(43) Pub. Date: Aug. 10, 2006

(54) Wagering game with enhanced keno game play feature

(75) Inventor: Alfred Thomas, Las Vegas, NV (US)

Correspondence Address: Daniel J. Burnham;JENKENS & GILCHRIST, A PROFESSIONAL CORPORATION, Ste. 2600, 225 W. Washington, Chicago, IL, 60606-3418, US

(73) Assignee: WMS Gaming, Inc.

(21) Appl. No.: 11/335,933

(22) Filed: Jan. 20, 2006

Related U.S. Application Data
(60) Provisional application No. 60/646,020, filed on Jan. 21, 2005.

(51) Int. Cl. G06F 19/00

(52) U.S. Cl. 463/18

(57) ABSTRACT

A method of playing a keno-type wagering game. The method includes conducting the keno-type wagering game at a gaming terminal. The keno-type wagering game has a plurality of game cards and a plurality of symbols. At least some of the plurality of symbols to be used by a player in the wagering game is displayed to the player. A first set of symbols from the plurality of symbols is selected, and applies to all of the plurality of game cards. The method further includes randomly generating a plurality of second sets of symbols from the plurality of symbols. Each of the plurality of second sets includes a first symbol and each of the first symbols of each of the plurality of second sets is displayed simultaneously. In response to at least one of the symbols of the plurality of second sets matching a symbol from the first set, the player receives an award.

### CROSS-REFERENCE TO RELATED APPLICATIONS

This application claims the benefit of priority of U.S. Provisional Patent Application No. 60/646,020 filed Jan. 21, 2005, which is hereby incorporated by reference in its entirety.

### FIELD OF THE INVENTION

The present invention relates generally to gaming terminals for playing a keno-type wagering game and, more particularly, to a keno-type wagering game having an enhancement feature.

### BACKGROUND OF THE INVENTION

Gaming machines, such as slot machines, video poker machines, video keno machines, and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are most likely to be attracted to the most entertaining and exciting of the machines.

Consequently, shrewd operators strive to employ the most entertaining and exciting machines available because such machines attract frequent play and, hence, increase profitability to the operator. In the competitive gaming machine industry, there is a continuing need for gaming machine manufacturers to produce new types of games, or enhancements to existing games, which will attract frequent play by enhancing the entertainment value and excitement associated with the game.

One concept that has been employed is the use of a progressive jackpot. In the gaming industry, a “progressive” involves collecting coin-in data from participating gaming device(s) (e.g., slot machines), contributing a percentage of that coin-in data to a jackpot amount, and awarding that jackpot amount to a player upon the occurrence of a certain jackpot-won event. The percentage of the coin-in is determined prior to any result being achieved and is independent of any result. A jackpot-won event typically occurs when a “progressive winning position” is achieved at a participating gaming device. If the gaming device is a slot machine, a progressive winning position may, for example, correspond to alignment of progressive jackpot reel symbols along a certain pay line. The initial progressive jackpot is a predetermined minimum amount. That jackpot amount, however, progressively increases as players continue to play the gaming machine without winning the jackpot. Further, when several gaming machines are linked together such that several players at several gaming machines compete for the same jackpot, the jackpot progressively increases at a much faster rate, which leads to further player excitement.

Another concept that has been successfully employed to enhance the entertainment value of a game is that of a “bonus” game which may be played in conjunction with a “basic” game. The bonus game may comprise any type of game, either similar to or completely different from the basic game, and is entered upon the occurrence of a selected event or outcome of the basic game. Such a bonus game produces a significantly higher level of player excitement than the basic game because it provides a greater expectation of winning than the basic game.

Some wagering games are keno games and involve players choosing a plurality of numbers on an electronic number board. Most keno games include electronic number boards of eighty numbers, and a player selects a set number (usually seven or less) of these eighty numbers. The selected numbers apply to a plurality of game cards being played by the player. Balls containing the numbers (or representations of balls containing the numbers) are then usually randomly selected from a hopper. If the numbers on the randomly selected balls match one or more of the player's selected numbers, the player has achieved a “hit.” Typically, a player is awarded credits for achieving three or more hits per card. The number boards and game cards may be electronic representations of a number board and a game card, and the hopper may be an electronic version of a hopper such that the keno game can be performed by a gaming terminal.

However, some people find playing keno to be tedious, as the balls for each of the electronic game cards are pulled one at a time. Also, because of the large number of balls from which to choose (often 80), the odds of winning can be quite low. Also, the game only awards players for the total number of hits per card, and not the total number of hits per number or hits per all cards played. Also, traditional keno does not include bonus balls, free games, or other incentives for a player to maintain interest.

Thus, there is a need for a wagering keno game with greater odds and faster play. There is also a need for a keno game that presents the player with awards for the total number of hits per number or for total cards played as well as providing other incentives such as bonuses and free games.

### SUMMARY OF THE INVENTION

According to one embodiment of the present invention, a method of playing a keno-type wagering game is provided. The method includes the step of conducting the keno-type wagering game at a gaming terminal. The keno-type wagering game has a plurality of game cards and a plurality of symbols. At least some of the plurality of symbols in the wagering game is displayed to the player. A first set of symbols from the plurality of symbols is selected such that the first set of symbols applies to all of the game cards. The method next randomly generates a plurality of second sets of symbols from the plurality of symbols. Each of the plurality of second sets includes a first symbol and all of the first symbols are displayed simultaneously. Each of the plurality of second sets of symbols corresponds to one of the plurality of game cards. In response to at least one of the symbols of the plurality of second sets matching a symbol from the first set, the player receives a winning award.

In accordance with another embodiment of the present invention, a method of playing a wagering game is provided. The method includes conducting the wagering game at a gaming terminal. The wagering game includes a plurality of symbols having a plurality of numbered symbols and at least one bonus symbol. The plurality of numbered symbols is displayed and a first set of numbers from the plurality of numbered symbols is selected. A set of symbols from the plurality of symbols is randomly selected, such that the selecting includes selecting a predetermined number of the numbered symbols. In response to the randomly selecting including selecting a bonus symbol, the bonus symbol does not count towards the predetermined number. Also, in response to at least part of the set of symbols matching at least part of the first set of numbers, a player is granted an award.

According to yet another embodiment of the present invention, a gaming terminal for playing a keno-type wagering game is provided. The wagering game has a plurality of symbols. The gaming terminal includes an input device and a display. The input device receives inputs from a player during the wagering game, the inputs include a wager amount. The display shows at least a portion of the plurality of symbols of the wagering game and a first set of selections from the plurality of symbols. Also, the display shows a plurality of randomly generated second sets of symbols that are chosen from the plurality of symbols. The plurality of second sets of symbols each include a first symbol and the first symbol of each of the plurality of second sets is displayed simultaneously.

In accordance with yet another embodiment of the present invention, a gaming terminal for playing a keno-type wagering game including a plurality of symbols is provided. The plurality of symbols has numbered symbols and at least one bonus symbol. The gaming terminal includes an input device that receives inputs from a player during the wagering game. These inputs include a wager amount. A display is also included on the gaming terminal. The display shows the plurality of numbered symbols of the wagering game, a first set of selections from the plurality of numbered symbols, and a plurality of randomly generated second sets of symbols that are chosen from the plurality of symbols. Each of the plurality of randomly generated second sets of symbols includes a predetermined number of the numbered symbols. In response to any of the randomly generated second sets of symbols including the bonus symbol, the bonus symbol does not count toward the predetermined number.

The above summary of the present invention is not intended to represent each embodiment or every aspect of the present invention, as there are several novel methods and gaming terminals incorporating this feature. The detailed description and Figures will describe many of the embodiments and aspects of the present invention.

### BRIEF DESCRIPTION OF THE DRAWINGS

The foregoing and other advantages of the invention will become apparent upon reading the following detailed description and upon reference to the drawings.

FIG. 1 is a perspective view of a video gaming terminal according to one embodiment of the present invention.

FIG. 2 is a block diagram of the gaming terminal of FIG. 1.

FIG. 3 an initial screen of a wagering game of the gaming terminal of FIG. 1.

FIG. 4 illustrates a subsequent screen of the wagering game of the gaming terminal of FIG. 1.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

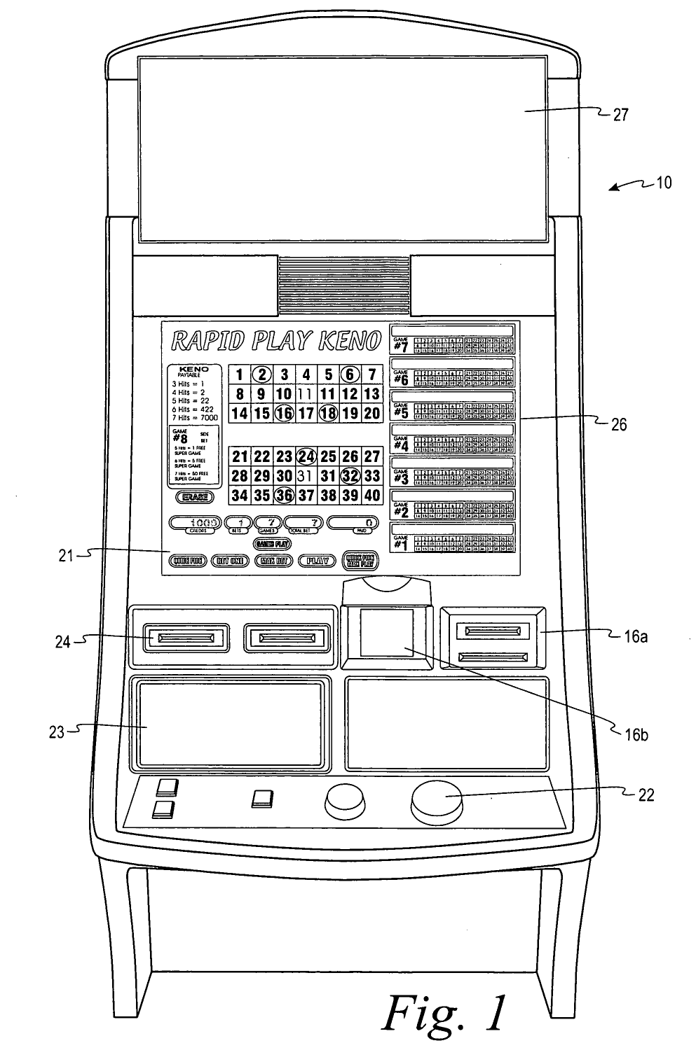

FIG. 1 shows a perspective view of a typical gaming terminal 10 used by gaming establishments, such as casinos. With regard to the present invention, the gaming terminal 10 may be an electromechanical or electrical gaming terminal configured to play keno. As shown, the gaming terminal 10 includes input devices, such as a wager acceptor 16 (shown as a card wager acceptor 16a and a cash wager accepter 16b), a touch screen 21, a push-button panel 22, and an information reader 24. For outputs, the gaming terminal 10 includes a payout mechanism 23, a main display 26 for displaying information about the basic wagering game, and a secondary display 27 that may display an electronic version of a pay table, and/or also possibly game-related information or other entertainment features. While these typical components found in the gaming terminal 10 are described below, it should be understood that numerous other elements may exist and may be used in any number of combinations to create various forms of a gaming terminal.

The wager acceptor 16 may be provided in many forms, individually of in combination. The cash wager acceptor 16a may include a coin slot acceptor or a note acceptor to input value to the gaming terminal 10. The card wager acceptor 16b may include a card-reading device for reading a card that has a recorded monetary value with which it is associated. The card wager acceptor 16b may also receive a card that authorizes access to a central account, which can transfer money to the gaming terminal 10.

Also included is the payout mechanism 23, which performs the reverse functions of the wager acceptor 16. For example, the payout mechanism 23 may include a coin dispenser or a note dispenser to output value from gaming terminal 10. Also, the payout mechanism 23 may be adapted to receive a card that authorizes the gaming terminal to transfer credits from the gaming terminal 10 to a central account.

The push button panel 22 is typically offered, in addition to the touch screen 21, to provide players with an option on how to make their game selections. Alternatively, the push button panel 22 provides inputs for one aspect of operating the game, while the touch screen 21 allows for inputs needed for another aspect of operating the game.

The outcome of the basic wagering game is displayed to the player on the main display 26. The main display 26 may take the form of a cathode ray tube (CRT), a high resolution LCD, a plasma display, LED, or any other type of video display suitable for use in the gaming terminal 10. As shown, the main display 26 includes the touch screen 21 overlaying the entire monitor (or a portion thereof) to allow players to make game-related selections.

In some embodiments, the information reader 24 is a card reader that allows for identification of a player by reading a card with information indicating his or her true identity. Currently, identification is used by casinos for rewarding certain players with complimentary services or special offers. For example, a player may be enrolled in the gaming establishment's players' club and may be awarded certain complimentary services as that player collects points in his or her player-tracking account. The player inserts his or her card into the information reader 24, which allows the casino's computers to register that player's wagering at the gaming terminal 10. The information reader 24 may also include a keypad (not shown) for entering a personal identification number (PIN). The gaming terminal 10 may require that the player enter his or her PIN prior to obtaining information. The gaming terminal 10 may use the secondary display 27 for providing the player with information about his or her account or other player-specific information. Also, in some embodiments, the information reader 24 may be used to restore assets that the player achieved during a previous game session and had saved.

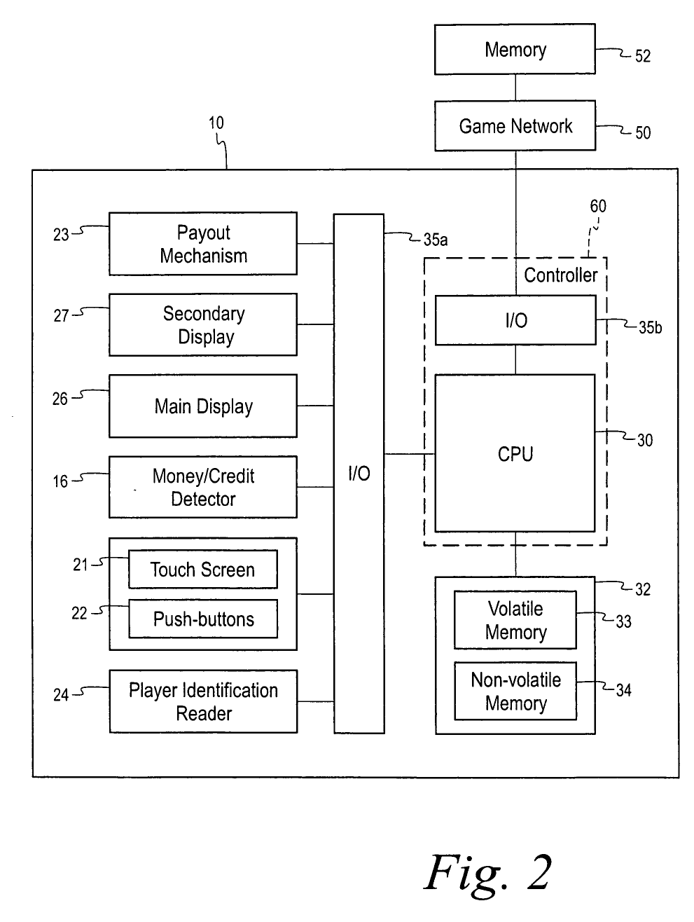

As shown in FIG. 2, the various components of the gaming terminal 10 are controlled by a central processing unit (CPU) 30 (such as a microprocessor or microcontroller). To provide the gaming functions, the CPU 30 executes a game program that allows for the randomly selected outcome. The CPU 30 is also coupled to or includes a local memory 32. The local memory 32 may comprise a volatile memory 33 (e.g., a random-access memory (RAM)) and a non-volatile memory 34 (e.g., an EEPROM). It should be appreciated that the CPU 30 may include one or more microprocessors. Similarly, the local memory 32 may include multiple RAM and multiple program memories.

Communications between the peripheral components of the gaming terminal 10 and the CPU 30 occur through input/output (I/O) circuits 35a. As such, the CPU 30 also controls and receives inputs from the peripheral components of the gaming terminal 10. Further, the CPU 30 communicates with external systems via the I/O circuits 35b. Although the I/O circuits 35 may be shown as a single block, it should be appreciated that the I/O circuits 35 may include a number of different types of I/O circuits.

The gaming terminal 10 is typically operated as part of a game control network 50 having control circuitry and memory devices. The game control network 50 may optionally include a system memory 52 for alternative storage of data. The game control network 50 can also include instructions for playing games, such as progressive jackpots that are contributed to by all or some of the gaming terminals 10 in the game control network 50. The gaming terminal 10 often has multiple serial ports, each port dedicated to providing data to a specific host computer system that performs a specific function (e.g., account system, player-tracking system, progressive game control system, etc . . . ). To set up a typical serial communication hardware link to the host system, the typical RS-232 point-to-point communication protocol that is often present in the gaming terminal 10 is converted to an RS-485 (or RS-485-type) master-slave protocol so as to take advantage of some of the advantages of the RS-485 capability (e.g., multi-drop capability that allows many gaming terminals 10 to communicate with the game control network 50). To perform this function, a custom interface board may be used by the gaming terminal 10 for each communication port in the gaming terminal 10. It should be noted that the gaming terminal 10 can initially be designed to be configured for a typical RS-485 protocol, instead of the typical RS-232 protocol. Further, the gaming terminal 10 may simply be designed for an Ethernet connection to the game control network 50.

The gaming terminal 10 and associated game control network 50 is capable of executing wagering games on or through a controller 60. Controller 60, as used herein, comprises any combination of hardware, software, and/or firmware that may be disposed or resident inside and/or outside of a gaming terminal 10 or like machine which may communicate with and/or control the transfer of data between the gaming terminal and a bus, another computer, processor, or device, and/or a service and/or a network. The network may include, but is not limited to a peer-to-peer, client/server, master/slave, star network, ring network, bus network, or other network architecture wherein at least one processing device (e.g., computer) is linked to at least one other processing device. The controller 60 may comprise the I/O circuits 35b and the CPU 30. In other embodiments, the CPU 30 may be housed outside of the controller 60, and a different processor may be housed within the controller 60. The controller 60, as used herein, may comprise one or more controllers. In one implementation, each gaming terminal 10 comprises, or is connected to, a controller 60, enabling each gaming terminal 10 to transmit and/or receive signals, preferably both, in a peer-to-peer arrangement. In another example, the controller 60 may be adapted to facilitate communication and/or data transfer for one or more gaming terminals 10 in a client/server or centralized arrangement. In one aspect, shown in FIG. 2, the controller 60 may connect the gaming terminal 10 via a conventional I/O port and communication path (e.g. serial, parallel, IR, RC, 10bT, etc.) to the game control network 50, which may include, for example, other gaming terminals connected together in the game control network 50.

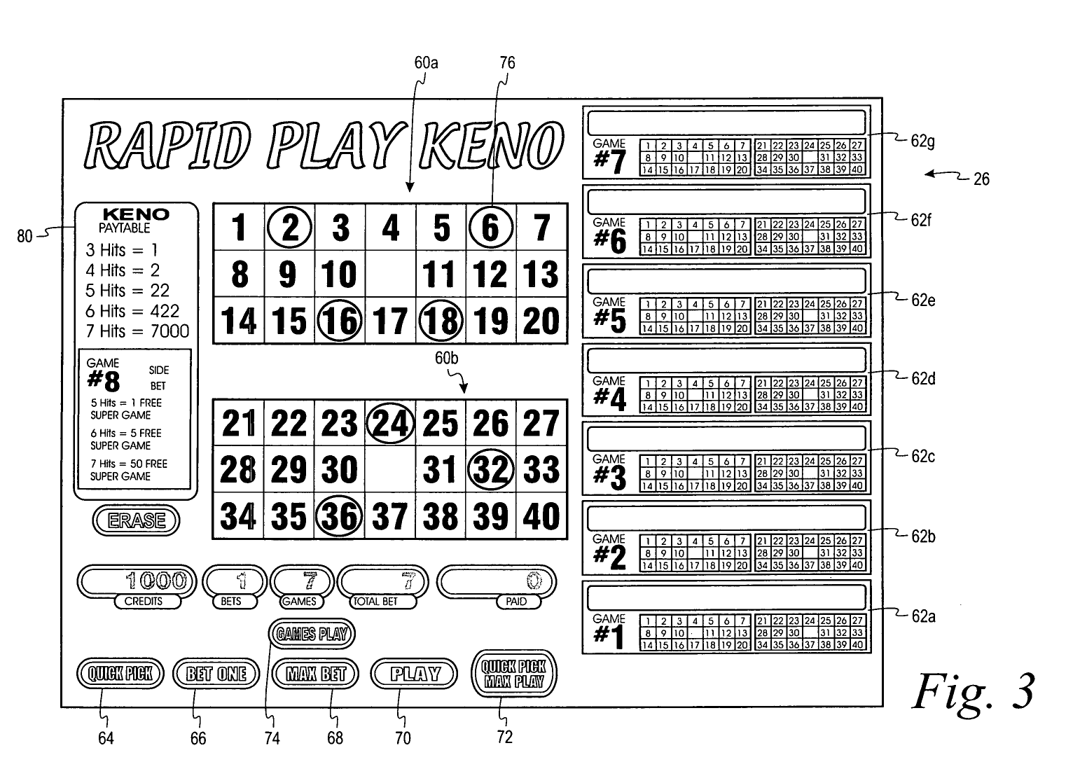

Turning now to FIG. 3, the main display 26 of one embodiment of the present invention is shown in more detail. In this embodiment, the basic game is a keno game. The main display 26 includes two electronic number boards 60a, 60b, containing the numbers 1-40. Traditional keno games include 80 numbers, making the odds of winning more difficult. A plurality of electronic game cards 62a-f and a bonus electronic game card 62g are shown to the right of the electronic number boards 60a, 60b. On the bottom of the main display 26, a quick-pick button 64, a bet-one button 66, a max-bet button 68, a play button 70, a quick-pick-max-play button 72, and a games button 74 are included. The buttons 64-74 may be permanent buttons or touch screen buttons.

In this particular embodiment, a player selects how many of the electronic game cards 62a-f to play by activating the games button 74 until the player reaches the number of electronic game cards 62a-f she or he desires to play. The player then chooses how much to wager on all of the selected electronic game card 62a-f by activating either the max-bet button 68 or the bet-one button 66. The max-bet button 68 places the maximum wager (in this embodiment, 10 credits) on each game card 62a-f being played. The bet-one button 66 allows the player to choose a wager less than the maximum up to the allowable maximum bet.

After making a wager, the player selects a plurality of numbers (up to seven) from the electronic number boards 60a, 60b. The same numbers are chosen for each of the electronic game cards 62a-g (including the bonus game played on the bonus-electronic-game card 62g, if being played, as described below). In other embodiments, the player may choose different numbers for each of the selected game cards 62a-g. Alternatively, the player could let the gaming terminal 10 randomly choose the numbers by selecting the quick-pick button 64. Once the player has chosen the numbers and placed the wager, the player can select the play button 70. Alternatively, the player can choose to make a wager, have the numbers chosen, and select to play all of the electronic game cards 62a-f by pressing the quick-pick-max-play button 72. Whether the numbers are selected by the player or by the gaming terminal, the chosen numbers are indicated on the electronic number boards 60a, 60b with circles 76 around them. In some embodiments, the numbers may also be highlighted on the electronic game cards 62a-g.

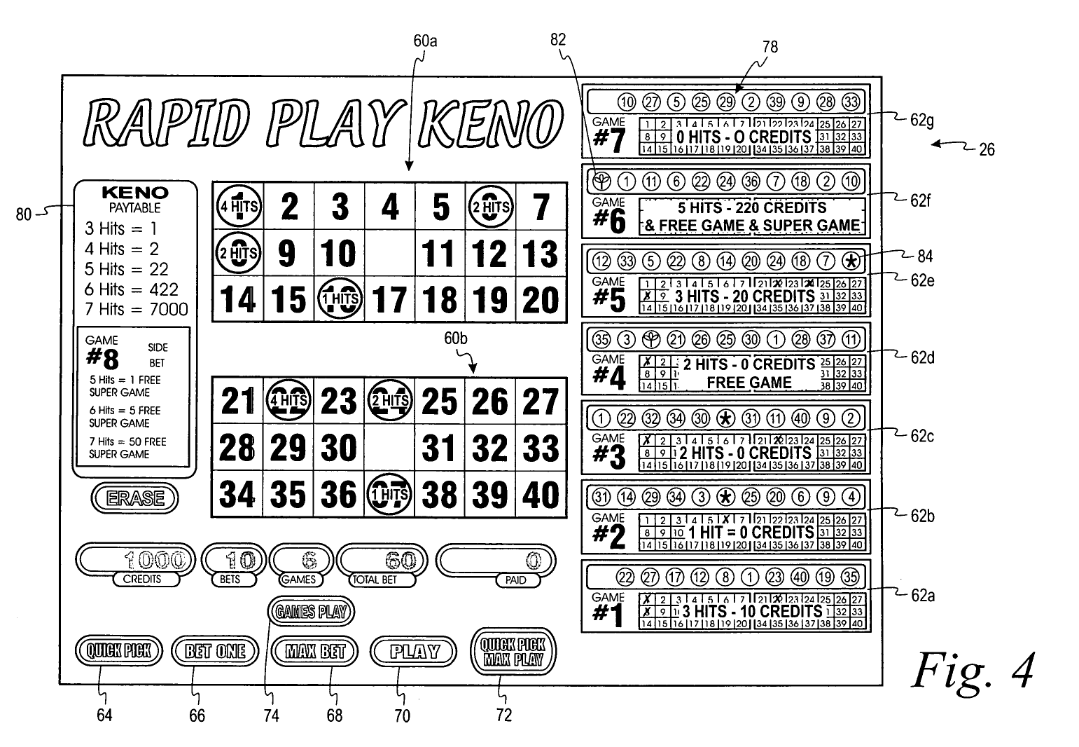

As shown in FIG. 4, ten numbered balls 78 are chosen for each of the electronic game cards 62a-g. The first six electronic game cards 62a-f are regular electronic game cards. The seventh electronic game card 62g is a bonus card that the player may play for free under the circumstances described below. Unlike in previous keno games, games are played simultaneously. In the present invention, the gaming terminal 10 utilizes multiple hoppers, one for each electronic game card 62a-g. In this embodiment, the multiple “electronic hoppers” are created by the CPU 30 (FIG. 2) of the gaming terminal 10 in that the CPU 30 randomly selects the balls for each electronic game card 62a-g without representations of the hoppers being shown to the player. The multiple “electronic hoppers” allow for the balls 78 for each electronic game card 62a-g to be selected at the same time. In other embodiments, representations of the multiple hoppers may be displayed on the main display 26. Because traditional keno games utilize only a single hopper, the play is often very slow, with only one number being chosen at a time. In this embodiment of the present invention, up to seven balls 78 (one for each electronic game card 62a-g) can be selected simultaneously or nearly simultaneously.

For each electronic game card 62a-g, the balls 78 are sequentially chosen from its hopper. The rate of selection may be constant or may be varied. For example, in some embodiments, the gaming terminal 10 may add suspense to the game by choosing the first six balls 78 rather quickly, but then slowing down the selection of the last four balls 78. Alternatively, the period of time between each selection may get longer for each selection. For example, the period of time between the second selection and the third selection may be 1½ times as long as the time between the first and second selection, while the time between the third and fourth selection may be twice as long as the time between the first and second selection, etc. By lengthening the time between the selections, the player may feel added suspense as he or she waits to see the last few balls that determine whether he or she won (or how much they won).

As shown in FIG. 4, the selected numbered balls 78 for each electronic game card 62a-g are shown on that electronic game card 62a-g. If any of the numbered balls 78 match a selected number, an “x” is put on that electronic game card 62a-g over the number, indicating a hit. After all of the balls 78 have been selected, the total number of hits is indicated on each of the electronic game cards 62a-g. The electronic game cards 62a-g indicate the total number of credits won for that particular game card. This allows the player to see how well he or she did on each electronic game card 62a-g, and not just an overall total. The number of credits correlates to a pay table 80, illustrated on the right side of the main display 26.

Also, after the balls 78 are selected, the number of times the player's chosen numbers resulted in a “hit” is displayed on the electronic number boards 60a, 60b. Also, an “x” is indicated on any unchosen number that is on one of the selected balls 78. This allows the player to see which of the played numbers were chosen most often and also, which numbers overall were chosen (or not chosen).

In some embodiments, the player may also be given awards for the total number of hits on all of the selected electronic game cards 62a-g. In other embodiments, the player may receive awards based upon the total number of hits each selected number has. For example, as shown in FIG. 4, the selected number “1” received four hits. The player may receive a credit award for having at least four hits on one selected number.

The present embodiment also includes two types of bonus balls—a green-clover bonus ball 82 and a blue-star bonus ball 84. The green-clover bonus ball 82 (shown on electronic game card 62f) results in the award of a free game on the seventh, or bonus, electronic game card 62g. The green-clover bonus ball 82 results in the free game even if the electronic game card with the green-clover bonus ball 82 does not have a winning payout. The free game is played on the seventh electronic game card 62g in the next round or independently of future game rounds at a time chosen by the player. The free game may provide a set payout, regardless of what the player wagers on the other electronic game cards. Alternatively, the free game may provide a payout corresponding to the amount wagered on the electronic game card that included the green-clover bonus ball 82. In other embodiments, the payout of the free game may correspond to the amount being wagered on other electronic game cards 62a-f while the free game is being played. The green-clover bonus ball 82 allows the player to have an extra card, and extra chances of winning.

The blue-star bonus ball 84 multiplies (in this embodiment, doubles) the awarded credits on the winning electronic game card 62a-g with the blue-star bonus ball 84. In the present embodiment, regardless of whether the green-clover bonus ball 82 and/or the blue-star bonus ball 84 is chosen, ten numbered balls are still selected for each electronic game card 62a-g. In other words, if five numbered balls have been selected for one of the electronic game cards 62a-g and then a bonus ball is selected, five more numbered balls are chosen. This increases the player's belief that he or she will achieve a winning outcome and, therefore, increases player satisfaction and excitement.

In some embodiments, the player is only eligible for the bonus balls 82, 84 if he or she meets a minimum wagering requirement. For example, in some embodiments, the player is required to play all of the game cards 62a-f to be eligible for the blue-star bonus ball 84 and place the maximum wager on each of the game cards 62a-f to be eligible for the green-clover bonus ball 82.

In another embodiment, if the bonus balls 82, 84 are selected, the player may be awarded credits for one or two hits on the electronic game card 62a-g with the bonus balls 82, 84. According to the pay table 80, the electronic game card 62a-g results in a credit win if the electronic game card 62a-g has three or more hits. In this embodiment, by having one of the bonus balls 82, 84, the player only needs one hit to win an award.

In another embodiment, instead of having the free game being played in the round after it is won, the player can “hold” onto the games, and play any accrued free games when he or she wants. A separate button (not shown) would be available on the main display 26 to allow the player to activate any free games that he or she has won, but not yet played.

In some embodiments, if a player should achieve five or more hits on a single electronic game card 62a-g, in addition to winning the credits in the pay table, the player is entered into a super bonus game or a progressive game. The progressive jackpot is paid by each wager from a plurality of linked gaming terminals 10. The player would win a part or the entire progressive jackpot by getting a certain number of hits.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A method of playing a keno-type wagering game, the method comprising:
conducting the keno-type wagering game at a gaming terminal, the keno-type wagering game having a plurality of game cards and a plurality of symbols;
displaying at least some of the plurality of symbols to be used by a player in the wagering game;
selecting a first set of symbols from the plurality of symbols, the first set of symbols applying to all of the plurality of game cards; and
randomly generating a plurality of second sets of symbols from the plurality of symbols, wherein each of the plurality of second sets includes a first symbol and each of the first symbols of all of the plurality of second sets are displayed simultaneously, and wherein each of the plurality of second sets of symbols corresponds to one of the plurality of game cards;
in response to at least one of the symbols of the plurality of second sets matching a symbol from the first set, awarding the player a winding award.

2. The method of claim 1 wherein all of the symbols in each of the plurality of second sets are selected simultaneously.

3. The method of claim 1 wherein each of the second sets have at least three symbols, and the at least three symbols for each of the second sets are chosen such that the first symbol is displayed prior to the second symbol and the second symbol is displayed prior to the third symbol.

4. The method of claim 3 wherein a period of time between the selection of each of the three symbols in each of the plurality of second sets is the same.

5. The method of claim 3 wherein a period of time between the selection of the first symbol and the second symbol is less than the period of time between the selection of the second symbol and the third symbol.

6. The method of claim 1 wherein the selecting is done by either a player or a controller.

7. The method of claim 1 wherein the plurality of symbols includes a plurality of numbers and at least one bonus symbol and the displaying the plurality of symbols comprises only displaying the plurality of numbers.

8. The method of claim 7 wherein the selecting a first set of symbols from the plurality of symbols comprises selecting from the plurality of numbers.

9. A method of playing a wagering game, the method comprising:
conducting the wagering game at a gaming terminal, the wagering game including a plurality of symbols having a plurality of numbered symbols and at least one bonus symbol;
displaying the plurality of numbered symbols;
selecting a first set of numbers from the plurality of numbered symbols to be used by the player in the wagering game; and
randomly selecting a set of symbols from the plurality of symbols, the selecting including selecting a predetermined number of the numbered symbols, wherein in response to the randomly selecting including selecting a bonus symbol, the bonus symbol not counting toward the predetermined number;
in response to at least part of the set of symbols matching at least part of the first set of numbers, awarding a player a winning award.

10. The method of claim 9 wherein the bonus symbol is a multiplier symbol, and in response to a winning combination being achieved in conjunction with the multiplier symbol being selected, the method further includes multiplying the winning award by a predetermined amount.

11. The method of claim 9 wherein the bonus symbol is a free-game symbol and in response to the free-game symbol being selected, the method further comprising awarding the player a free game.

12. The method of claim 11 wherein the free game is played at a time determined by either the gaming terminal or the player.

13. The method of claim 9 wherein a winning combination is achieved by having a predetermined number of the randomly selected symbols match the first selected numbers.

14. The method of claim 13 further comprising, in response to having a number greater than the predetermined number of randomly selected symbols match the first selected numbers, awarding the player a bonus game.

15. A gaming terminal for playing a keno-type wagering game, the wagering game including a plurality of symbols, comprising:
an input device for receiving inputs from a player during the wagering game, the inputs including a wager amount; and
a display for showing at least a portion of the plurality of symbols of the wagering game and a first set of selections from the plurality of symbols, the display further showing a plurality of randomly generated second sets of symbols, chosen from the plurality of symbols, wherein the plurality of second sets of symbols each include a first symbol and the first symbol of each of the plurality of second sets being displayed simultaneously.

16. The gaming terminal of claim 15 further comprising a plurality of hoppers, each of the hoppers containing the plurality of symbols for the second sets.

17. The gaming terminal of claim 15 wherein the plurality of symbols includes a plurality of numbers and at least one bonus symbol and the showing the plurality of symbols comprises only displaying the plurality of numbers.

18. The gaming terminal of claim 17 wherein the first set of selections from the plurality of symbols comprises only selections from the plurality of numbers.

19. The gaming terminal of claim 15 further comprising a controller coupled to the display and the input device, the controller causing the display to show the at least a portion of the plurality of symbols.

20. The gaming terminal of claim 19 wherein the controller is external to the gaming terminal.
